(19) United States
(12) Patent Application Publication
(10) Pub. No.: US 2006/0274616 A1
(43) Pub. Date: Dec. 7, 2006

(54) OPC-performing method restudying optical source drive characteristics after OPC recording and OPC measurement and optical recording/reproducing apparatus using the same

(75) Inventors: Jin-woo Yu, Suwon-si (KR); Tatsuhiro Otsuka, Suwon-si (KR); Jong-lin Ko, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/444,470

(22) Filed: Jun. 1, 2006

(30) Foreign Application Priority Data
Jun. 1, 2005 (KR) 2005-46673

(51) Int. Cl. G11B 7/12

(52) U.S. Cl. 369/47.53

(57) ABSTRACT

An optical recording/reproducing apparatus and an OPC-performing method are provided for restudying drive characteristics of an optical source after performing OPC test recording and OPC measurement to ensure accurate optimum power control (OPC) for recording data on an optical disc, particularly, when the drive characteristics vary according to temperature changes of the optical source. The OPC-performing method comprises performing OPC recording as test recording for OPC and OPC measurement as measurement of an OPC recording state; performing a power analysis of drive characteristics of an optical source, and obtaining optical source drive characteristics after the OPC recording and the OPC measurement; and performing OPC calculation for determination of an optimum optical source drive level as an optical source drive level for enabling optimum beams of optimum recording power to be emitted from the optical source, based on the OPC recording state and the optical source drive characteristics obtained. As a result, an optimum optical source drive level can be accurately obtained, since the OPC calculation is performed based on the optical source drive characteristics after the temperature of the optical source has increased.

### CROSS-REFERENCE TO RELATED APPLICATIONS

This application claims all benefits accruing under 35 U.S.C. § 119 from Korean Patent Application No. 2005-46673, filed on Jun. 1, 2005, the disclosure of which is incorporated by reference herein.

### BACKGROUND OF THE INVENTION

1. Field of the Invention

The present invention relates to optical recording media and an optical recording/reproducing apparatus employing the same, and more particularly to an OPC-performing method restudying optical source drive characteristics after an optimum power control (OPC) recording and OPC measurement, and an optical recording/reproducing apparatus using the same.

2. Related Art

Recording media such as optical discs have been developed and commercialized to record and store image data and sound data with improved performance for a long period of time. Such optical disks can be classified as either compact disks (CDs) or digital versatile disks (DVD) according to data recording capacity. Examples of optical disks that can be recorded, deleted, and reproduced include 650 MB CD-Rs, CD-rewritables (RWs), 4.7 GB DVD+R/RWs, DVD-random access memories (RAMs), and DVD-R/RWs. Examples of optical disks that are dedicated for data reproduction include 650 MB CDs and 4.7 GB DVD-read only memories (ROMs). In addition, due to limitations in increasing storage capacity of the conventional DVD-ROM, standardization for new high-density optical discs, for example, blue-ray discs (BDs) and HD-DVD, has been rapidly advanced.

When data is recorded on a high-density optical disc, an optimum power control (OPC) procedure is performed to determine an optimum recording power for recording data on an associated optical disc, i.e., the best recording laser power setting for each optical disc and a recording/reproducing apparatus combination.

In general, before recording data onto an optical disc, the optical recording/reproducing apparatus performs an OPC procedure over a test recording area of the optical disc. Through an OPC performance, an optimum LD drive level is determined in order for optical beams of an optimum recording power to be emitted from a laser diode (LD).

The OPC procedure has a series of steps, including: (1) studying drive characteristics of a laser diode (LD); (2) performing OPC recording as test recording while driving the laser diode (LD) based on the drive characteristics; (3) performing OPC measurement for measurement of an OPC recording state; and (4) performing OPC calculation for determination of an optimum LD drive level based on a result of the OPC measurement and the LD drive characteristics.

However, the OPC recording and the OPC measurement often increase a temperature of the laser diode (LD). If the temperature of the laser diode (LD) rises, the LD drive characteristics also change. Despite the change to the LD drive characteristics as described above, the OPC calculation is performed based on the LD drive characteristics detected before any change of the temperature of the laser diode (LD).

Since the OPC calculation is not performed based on the LD drive characteristics detected after the temperature of the laser diode (LD) rises as described above, the optimum LD drive level is often assessed incorrectly. If the laser diode (LD) is driven according to an inaccurate, or incorrect optimum LD drive level, optical beams of an inaccurate optimum recording power are emitted, which results in a higher error occurrence possibility in recording data on an optical disc.

### SUMMARY OF THE INVENTION

Various aspects and example embodiments of the present invention advantageously provide an OPC-performing method and an optical recording/reproducing apparatus employing the same, which, in order to prevent error occurrence possibility from high density optical discs, perform OPC calculation based on optical source drive characteristics based on an update analysis of drive characteristics of an optical source changed in temperature due to OPC recording and OPC measurement.

Additional aspects and/or advantages of the invention will be set forth in part in the description which follows and, in part, will be obvious from the description, or may be learned by practice of the invention.

In accordance with an aspect of the present invention, an OPC-performing method comprises: performing OPC recording as test recording for OPC and OPC measurement as measurement of an OPC recording state; analyzing drive characteristics of an optical source, and obtaining optical source drive characteristics after the OPC recording and the OPC measurement; and performing OPC calculation to determine an optimum optical source drive level as an optical source drive level for enabling an optical beam of an optimum recording power to be emitted from the optical source, based on the OPC recording state and the optical source drive characteristics obtained.

The optical source drive characteristics vary according to temperature changes of the optical source. Further, the optical source drive characteristics vary according to the temperature changes of the optical source due to at least one of the OPC recording and the OPC measurement. Furthermore, the analysis of the drive characteristics of an optical source includes obtaining an optical source drive level-measurement power correlation as a correlation between the optical source drive level and the measurement power as an optical power measured at an optical detection element for monitoring when the optical source is driven according to the optical source drive level.

Preferably, the OPC calculation includes determining an optimum recording power based on the OPC recording state; calculating the measurement power measured when an optical beam of the determined optimum recording power is emitted from the optical source; and determining, as the optimum optical source drive level, an optical source drive level corresponding to the calculated measurement power based on the optical source drive level-measurement power correlation obtained during the power analysis.

Further, a pre-studying step is further provided to obtain the optical source drive characteristics through the analysis of the drive characteristics of the optical source before the OPC recording and the OPC measurement, wherein the OPC recording is performed based on the optical source drive characteristics obtained.

In accordance with another aspect of the present invention, an optical recording apparatus comprises an optical source for emitting an optical beam used for recording data onto an optical disc; and a control unit for studying drive characteristics of the optical source after OPC recording as test recording and OPC measurement as measurement of an OPC recording state, obtaining optical source drive characteristics, and determining an optimum optical source drive level as an optical source drive level for enabling an optical beam of an optimum recording power to be emitted from the optical source based on the OPC recording state and the optical source drive characteristics.

The optical source drive characteristics vary according to temperature changes of the optical source. Further, the optical source drive characteristics vary according to the temperature changes of the optical source due to at least one of the OPC recording and the OPC measurement.

According to an aspect of the present invention, the control unit obtains as the optical source drive characteristics, an optical source drive level-measurement power correlation indicating a correlation between the optical source drive level and the measurement power as an optical power measured at an optical detection element for monitoring when the optical source is driven according to the optical source drive level.

According to another aspect of the present invention, the control unit determines an optimum recording power based on the OPC recording state, calculates the measurement power measured at the optical detection element for monitoring when an optical beam of the determined optimum recording power is emitted from the optical source, and determines as the optimum optical source drive level, an optical source drive level corresponding to the calculated measurement power based on the optical source drive level-measurement power correlation.

Further, the OPC recording is performed based on optical source drive characteristics obtained through the analysis of the drive characteristics of the optical source before the OPC recording and the OPC measurement.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the invention are limited only by the terms of the appended claims. The following represents brief descriptions of the drawings, wherein:

FIG. 1 is a block diagram of an example optical recording/reproducing apparatus for performing an OPC through restudying optical source drive characteristics after OPC recording and OPC measurement according to an embodiment of the present invention;

FIG. 2 is a flow chart for explaining an OPC-performing method for restudying optical source drive characteristics after completing OPC recording and OPC measuring according to an embodiment of the present invention; and

FIGS. 3A-3B show example recording power measurement power correlations, at block S260 shown in FIG. 2.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

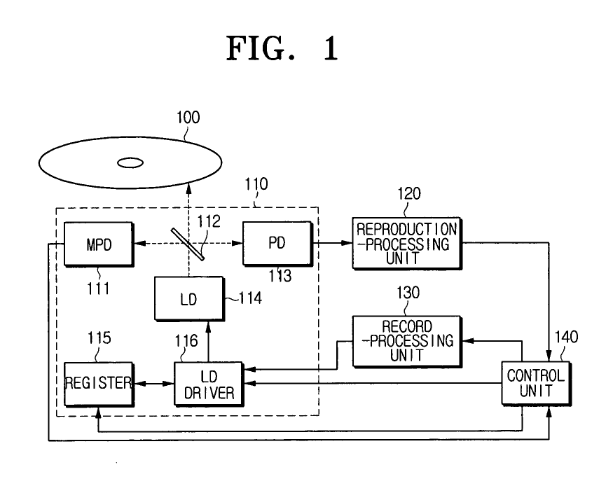

FIG. 1 is a block diagram of an example optical recording/reproducing apparatus according to an embodiment of the present invention. In FIG. 1, the flow lines shown in solid lines denote paths of electrical signals such as a drive signal, control signal, information signal, and the like, and the flow lines shown in dotted lines denote paths of optical beams.

In performing an optimum power control or calibration (OPC), the optical recording/reproducing apparatus performs the studying of optical source drive characteristics again after completing OPC recording and OPC measurement, and performs OPC calculation based on the optical source drive characteristics updated through the restudying. The studying of the optical source drive characteristics is repeated between the OPC recording/measurement and the OPC calculation so as to obtain optical source drive characteristics changed in temperature due to the OPC recording/measurement and to use the obtained optical source drive characteristics for the OPC calculation.

As shown in FIG. 1, the optical recording/reproducing apparatus comprises an optical disc 100, an optical pickup unit 110, a reproduction-processing unit 120, a record-processing unit 130, and control unit 140. In addition, other units such as a servo unit, a motor driver, a key-input unit and a memory may also be arranged but not shown. For purposes of brevity, the optical recording/reproducing apparatus, albeit in whole or in part, can also be referred to as a drive system which can be internal (housed within a host) or external (housed in a separate box that connects to a host). The optical disc can be any high-density medium, such as blue-ray disc (BD), high-density DVD (HD DVD) and other advanced optical disc (AOD); however, other optical discs can also be utilized, including DVD, DVD-R, DVD-RW, DVD+RW, DVD-RAM, DVD-ROM, CD, CD-R, CD-RW, and CD-ROM. In addition, such an optical recording/reproducing apparatus may be a single apparatus, or may be separated into a recording apparatus (i.e., digital video disc recorder “DVDR”) and a reading apparatus (i.e., compact disc player “CDP” or digital video disc player “DVDP”).

The optical pickup unit 110 records target data outputted from the record-processing unit 130 onto a mounted optical disc 100. In addition, the optical pickup unit 110 reads data recorded on the optical disc 100, and outputs an electrical signal corresponding to the read data to the reproduction-processing unit 120.

The optical pickup unit 110 includes a monitor photo diode (MPD) 111, a beam splitter 112, a photo diode (PD) 113, a laser diode (LD) 114, a memory, such as a register 115, and an LD driver 116.

The laser diode (LD) 114 is an optical source used for selectively emitting optical recording beams or optical reproduction beams. As described herein, the “recording beams” are optical beams used for recording data onto the mounted optical disc 100, and the “reproduction beams” are optical beams used for reading data recorded on the optical disc 100.

The LD driver 116 drives the laser diode (LD) 114 according to a LD drive level set in the register 115. That is, the LD driver 116 generates an LD drive signal based on the LD drive level set in the register 115, and drives the laser diode (LD) 114 to generate an optical beam in accordance with the generated LD drive signal.

The beam splitter 112 splits an optical beam emitted from the LD 114 (hereinafter, referred to as “an LD emission beam”) into two optical beams. In detail, the beam splitter 120 transmits 70˜80% of the LD emission beam to the optical disc 100, and reflects 20˜30% of the LD emission beam to the monitor photo diode (MPD) 111. Hereinafter, for the sake of convenience, the LD emission beam transmitted from the beam splitter 112 to the optical disc 100 is referred in short to as “a TD beam” (To Disk Beam), and the LD emission beam reflected from the beam splitter 112 to the MPD 111 is referred in brief to as “a TM beam” (To MPD beam).

The monitor photo diode (MPD) 111 measures an optical power of the TM beam, and transfers a result of the measurement to the control unit 140. The photo diode (PD) 113 converts into an electric signal, the TD beam reflected again from the beam splitter 112 after reflected from the optical disc 100, and applies the electric signal to the reproduction-processing unit 120.

The control unit 140 controls overall operations of the present optical recording/reproducing apparatus. Specifically, the control unit 140 controls an optimum power control (OPC) procedure of the optical recording/reproducing apparatus in order to determine an optimum recording power for recording data on an optical disc 100, particularly, after the LD drive characteristics vary according to temperature changes of the laser diode (LD). Parameters used to perform the OPC procedure are typically stored in the memory, such as, the register 115, and can be accessed by the control unit 140 prior to performing the OPC procedure.

In detail, upon termination of (i) the analysis of LD drive characteristics of a laser diode (LD), (ii) the OPC recording, and (iii) the OPC measurement, the control unit 140 restudies or re-analyze (iv) the LD drive characteristics, and (v) performs the OPC calculation based on the LD drive characteristics updated. This is why the LD drive characteristics analysis is repeated between (iii) the OPC measurement and (v) the OPC calculation to (iv) obtain LD drive characteristics as updated and changed in temperature due to (ii) the OPC recording and (iii) the OPC measurement and (v) use the LD drive characteristics for the OPC calculation.

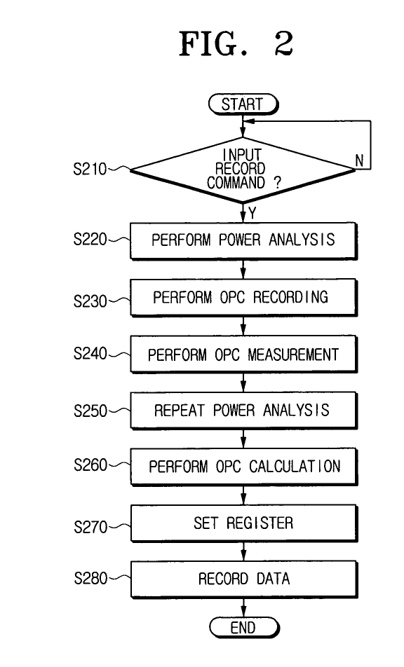

Hereinafter, an OPC procedure controlled by the control unit 140 will be described in detail with reference to FIG. 2. FIG. 2 is a flow chart for explaining an OPC procedure through the re-analysis of the optical source drive characteristics after completions of the OPC recording and OPC measurement.

Further, hereinafter, for the sake of convenience, the term “LD drive level-measurement power correlation” is introduced as the LD drive characteristics indicating the optical source drive characteristics, which is correlation between an LD drive level and optical power of TM beams measured at the monitor photo diode (MPD) 111 (hereafter, referred to as “measurement power”) when the laser diode (LD) 114 is driven according to the LD drive level. Further, studying of the LD drive level-measurement power correlation is referred in brief to as “power analysis.”

As shown in FIG. 2, if a record command is inputted as a command for recording data on an optical disc 100 at block S210, the control unit 140 controls operations of the optical pickup unit 110, including an optimum power control (OPC) procedure to determine an optimum recording power for recording data on an optical disc 100, even when the LD drive characteristics vary according to temperature changes of the laser diode (LD) 114. Specifically, upon receipt of an input record command, the control unit 140 performs a power analysis, that is, to study the power of an optical source, i.e., drive characteristics of a laser diode (LD) 114 at block S220. Through the power analysis, the control unit 140 obtains a LD drive level-measurement power correlation. For purposes of making a distinction with another LD drive level-measurement power correlation obtained through block S250 which will be later described, the LD drive level-measurement power correlation obtained through block S220 is referred to as a first LD drive level-measurement power correlation.

Next, the control unit 140 controls the operations of the pickup unit 110 to perform the OPC recording at block S230. The OPC recording refers to test recording for an OPC, and, in detail, refers to the test recording in a test recording area provided on the optical disc 100, while varying an optical power of the recording beam emitted from the laser diode (LD) 114 (hereafter, referred in brief to as “recording power”). When the OPC recording is performed at block S230, the first LD drive level-measurement power correlation is used which is obtained through block S220.

During the OPC recording procedure at block S230, the control unit 140 obtains a recording power-measurement power correlation as a correlation between the recording power and the measurement power through the measurement power outputted from the monitor photo diode (MPD) 111. The recording power/measurement power correlation refers to the correlation between the recording power and the measured power outputted from the monitor photo diode (MPD) 111 when the optical beam of the recording power is outputted from the laser diode (LD) 114.

Next, the control unit 140 performs the OPC measuring by using a reproduction signal applied through the optical pickup unit 110 and the reproduction-processing unit 120 at block S240. The OPC measurement refers to the measurement of an OPC recording state as state of the OPC recording performed at block S230. The control unit 140 obtains the OPC recording state through the OPC measurement at block S240.

After the OPC recording at block S230 and the OPC measurement at block S240, the control unit 140 controls the operations of the optical pickup unit 110 to repeat the power analysis at block S250. The control unit 140 obtains a second LD drive level-measurement power correlation that is different from the first LD drive level-measurement power correlation through the repetition of the power analysis at block S250.

The second LD drive level-measurement power correlation obtained through block S250 becomes different from the first LD drive level-measurement power correlation obtained through block S220, since the temperature of the laser diode (LD) 114 has been increased due to the OPC recording at block S230 and the OPC measurement at block S240. The measurement power becomes varied if the temperature of the laser diode (LD) 114 changes, even though the LD drive level remains the same.

Next, the control unit 140 performs the OPC calculation at block S260. The OPC calculation refers to determination of an optimum LD drive level based on the recording power/measurement power correlation obtained through block S230, the OPC recording state obtained through block S240, and the second LD drive level-measurement power correlation obtained through block S250. The optimum LD drive level represents an LD drive level for an optical beam of an optimum recording power to be emitted from the laser diode (LD) 114, shown in FIG. 1.

In more detail, during block S260, the control unit 140 determines: (i) an optimum recording power based on the OPC recording state, calculates (ii) the measurement power outputted from the monitor photo diode (MPD) 111 when the optical beams of the determined optimum recording power are emitted from the laser diode (LD) 114 based on the recording power-measurement power correlation, and determines (iii) a LD drive level corresponding to the calculated measurement power as an optimum LD drive level based on the second LD drive level-measurement power correlation.

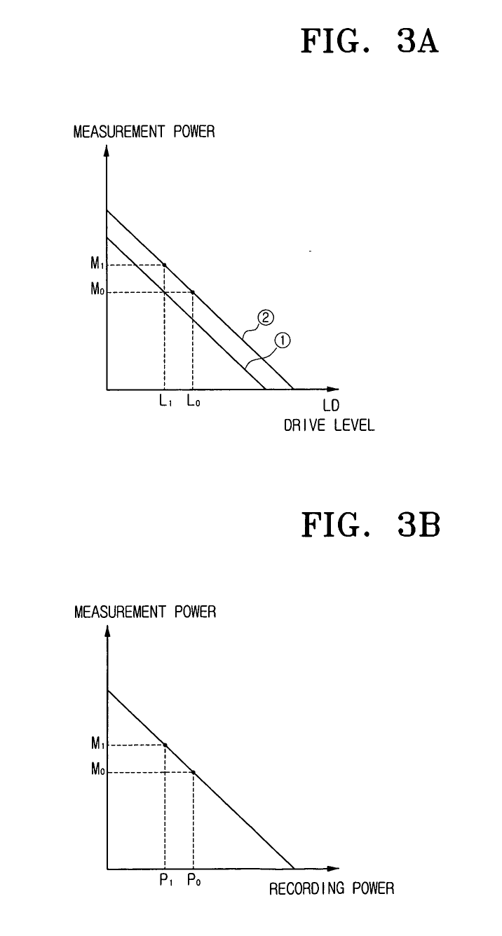

For additional explanation at block S260, FIG. 3A shows an example correlation between different optical source (i.e., laser diode “LD”) drive levels and a measurement power obtained when an optical source (i.e., laser diode “LD”) is driven according to the optical source drive level. FIG. 3B shows an example correlation between an optimum recording power and a measurement power.

Specifically, FIG. 3A shows the first LD drive level-measurement power correlation \textcircled{1} and the second LD drive level-measurement power correlation \textcircled{2}, and FIG. 3B shows the recording power-measurement power correlation.

It can be seen from FIGS. 3A-3B, if an optimum recording power is determined at “P₀” and an optical beam at “P₀” is emitted from the laser diode (LD) 114, the measurement power outputted from the monitor photo diode (MPD) 111 corresponds to a measurement power “M₀” according to the recording power-measurement power correlation shown in FIG. 3B. Further, it can be seen from FIGS. 3A-3B that the LD drive level at “M₀” is determined at “L₀”, according to the second LD drive level-measurement power correlation \textcircled{2} shown in FIG. 3A.

If the first LD drive level-measurement power correlation \textcircled{1} is used as described in typical OPC procedure, the LD drive level at “M₀” is determined at “L₁” rather than at “L₀”, as shown in FIG. 3A. However, since the temperature of the laser diode (LD) 114 has been increased due to the OPC recording at block S230 and the OPC measurement at block S240, the laser diode (LD) 114 operates according to the second LD drive level-measurement power correlation \textcircled{2}. Accordingly, if the laser diode (LD) 114 is driven at “L₁”, the recording power becomes “P₁” rather than the optimum recording power “P₀”, as shown in FIG. 3B, since the measurement power corresponding to “L₁” is “M₁” according to the second LD drive level-measurement power correlation \textcircled{2} and the recording power corresponding to “M₁” is “P₁” according to the recording power-measurement power correlation.

When block S260 is completed, the control unit 140 sets an optimum LD drive level determined through the OPC calculation into the register 115 at block S270.

Next, the control unit 140 controls the operations of the optical pickup unit 110 and the record-processing unit 130 to record data on the optical disc 100 at block S280. During block S280, the data is recorded in optimum conditions since the LD driver 116 drives the laser diode (LD) 114 according to an optimum LD drive level set in the register 115.

So far, description has been made in detail on the procedures of restudying the LD drive level-measurement power correlation, after the OPC recording and OPC measurement, and determining the optimum LD drive level through the OPC calculation based on the LD drive level-measurement power correlation updated through the restudying or re-analysis.

Description has been made on the present embodiments with the LD drive level-measurement power correlation taken as the optical source drive characteristics for example, for convenient explanation. Accordingly, the present invention can be applied with different optical source drive characteristics rather than the LD drive level-measurement power correlation.

Further, the present invention is appropriate when the temperature of an optical source is highly increased due to the OPC recording performed with relatively high recording power, as in OPC performance over a blu-ray disk (BD). However, the present invention is not limited to the above, but can be applicable to all optical discs, including a digital versatile disc (DVD), a compact disc (CD), and high-density DVD (HD-DVD), including any other optical discs.

As described above, the present invention can restudy or re-analyze the optical source drive characteristics changed in temperature due to the OPC recording and the OPC measurement, and perform the OPC calculation based on the updated optical source drive characteristics. As a result, an optical recording/reproducing apparatus according to the present invention can accurately determine an optimum optical source drive level since the OPC calculation is performed based on the optical source drive characteristics after the temperature of an optical source (i.e., laser diode “LD”) has increased. Likewise, error occurrence possibility in recording data onto an optical disc can be reduced, if not eliminated, thereby enabling an optical source to be driven according to an accurate optimum optical source drive level and optical beams of the accurate optimum recording power to be emitted from the optical source.

While the present invention has been particularly shown and described with reference to exemplary embodiments thereof, it will be understood by those of ordinary skill in the art that various changes in form and details may be made therein without departing from the spirit and scope of the present invention. For example, other recording media, such as DVD, DVD-R, DVD-RW, DVD+RW, DVD-RAM, DVD-ROM, CD, CD-R, CD-RW, CD-ROM and other holographic data storage devices may be utilized, as long as the OPC is implemented in the manner as described with reference to FIG. 1, FIG. 2, and FIG. 3. In addition, a recording test zone can be fixed and/or flexible in designated areas of an optical disc. Likewise, the result of the power analysis at block S250, shown in FIG. 2, can be stored elsewhere in an example recording/reproducing apparatus, shown in FIG. 1. Similarly, the system controller can be implemented as a chipset having firmware, or alternatively, a general or special purposed computer programmed to implement methods as described with reference to FIG. 2. Accordingly, it is intended, therefore, that the present invention not be limited to the various example embodiments disclosed, but that the present invention includes all embodiments falling within the scope of the appended claims.

What is claimed is:

1. An optimum power control (OPC)-performing method, comprising:
performing OPC recording as test recording for OPC and OPC measurement as measurement of an OPC recording state;
analyzing drive characteristics of an optical source after the OPC recording and the OPC measurement, and obtaining optical source drive characteristics; and
performing OPC calculation to determine an optimum optical source drive level as an optical source drive level for enabling an optical beam of an optimum recording power to be emitted from the optical source, based on the OPC recording state and the optical source drive characteristics obtained.

2. The method as claimed in claim 1, wherein the optical source drive characteristics vary according to temperature changes of the optical source.

3. The method as claimed in claim 2, wherein the optical source drive characteristics vary according to the temperature changes of the optical source due to at least one of the OPC recording and the OPC measurement.

4. The method as claimed in claim 1, wherein the analysis includes obtaining an optical source drive level-measurement power correlation as a correlation between the optical source drive level and the measurement power as an optical power measured when the optical source is driven according to the optical source drive level.

5. The method as claimed in claim 4, wherein the OPC calculation comprises:
determining an optimum recording power based on the OPC recording state;
calculating the measurement power measured when an optical beam of the determined optimum recording power is emitted from the optical source; and
determining, as the optimum optical source drive level, an optical source drive level corresponding to the calculated measurement power based on the optical source drive level-measurement power correlation obtained.

6. The method as claimed in claim 1, further comprising pre-studying the optical source drive characteristics obtained before the OPC recording and the OPC measurement, wherein the OPC recording is performed based on the optical source drive characteristics obtained during the pre-studying.

7. An optical disc apparatus comprising:
an optical source arranged to emit an optical beam used for recording data on an optical disc; and
a control unit arranged to analyze drive characteristics of the optical source after OPC recording as test recording for OPC and OPC measurement as measurement of an OPC recording state, and obtain optical source drive characteristics, and then determine an optimum optical source drive level as an optical source drive level for enabling an optical beam of an optimum recording power to be emitted from the optical source based on the OPC recording state and the optical source drive characteristics.

8. The optical disc apparatus as claimed in claim 7, wherein the optical source drive characteristics vary according to temperature changes of the optical source.

9. The optical disc apparatus as claimed in claim 8, wherein the optical source drive characteristics vary according to the temperature changes of the optical source due to at least one of the OPC recording and the OPC measurement.

10. The optical disc apparatus as claimed in claim 7, wherein the control unit obtains as the optical source drive characteristics, an optical source drive level-measurement power correlation indicating a correlation between the optical source drive level and the measurement power as an optical recording power measured when the optical source is driven according to the optical source drive level.

11. The optical disc apparatus as claimed in claim 10, wherein the control unit determines an optimum recording power based on the OPC recording state, calculates the measurement power measured when an optical beam of the determined optimum recording power is emitted from the optical source, and determines, as the optimum optical source drive level, an optical source drive level corresponding to the calculated measurement power based on the optical source drive level-measurement power correlation.

12. The optical disc apparatus as claimed in claim 7, wherein the OPC recording is performed based on optical source drive characteristics obtained through the analysis of the drive characteristics of the optical source before the OPC recording and the OPC measurement.

13. An apparatus comprising:
an optical source to irradiate a laser beam onto an optical disc for recording and reproducing data;
a memory to store parameters to perform an optimum power control (OPC) procedure;
a controller arranged to control the optical source and to access the memory for performing the OPC procedure to determine an optimum recording power of the laser beam suitable for recording data on the optical disc,
wherein the controller is configured to obtain drive characteristics of the optical source after OPC recording as test recording and OPC measurement as measurement of an OPC recording state, and determine an optimum optical source drive level for enabling the laser beam having an optimum recording power to be irradiated from the optical source based on the OPC recording state and the optical source drive characteristics.

14. The apparatus as claimed in claim 13, wherein the optical source drive characteristics vary according to temperature changes of the optical source.

15. The apparatus as claimed in claim 13, wherein the optical source drive characteristics vary according to the temperature changes of the optical source due to at least one of the OPC recording and the OPC measurement.

16. The apparatus as claimed in claim 13, wherein the control unit obtains as the optical source drive characteristics, an optical source drive level-measurement power correlation indicating a correlation between the optical source drive level and the measurement power as an optical recording power measured when the optical source is driven according to the optical source drive level.

17. The apparatus as claimed in claim 13, wherein the control unit determines the optimum recording power based on the OPC recording state, calculates the measurement power measured when the laser beam of the determined optimum recording power is emitted from the optical source, and determines, as the optimum optical source drive level, an optical source drive level corresponding to the calculated measurement power based on the optical source drive level-measurement power correlation.

18. The apparatus as claimed in claim 13, wherein the OPC recording is performed based on optical source drive characteristics obtained through the analysis of the optical source drive characteristics before the OPC recording and the OPC measurement.

19. A method of performing optimum power control (OPC) in an optical disc apparatus, comprising:
obtaining drive characteristics of an optical source emitting a laser beam after performing an OPC recording as test recording and OPC measurement as measurement of an OPC recording state; and
determining an optimum optical source drive level for enabling the laser beam having an optimum recording power to be emitted from the optical source suitable for recording data on the optical disc, based on the OPC recording state and the optical source drive characteristics.

20. The method according to claim 19, wherein the optical source drive characteristics vary according to temperature changes of the optical source.

21. The method as claimed in claim 19, wherein the optical source drive characteristics vary according to the temperature changes of the optical source due to at least one of the OPC recording and the OPC measurement.

22. The method as claimed in claim 19, wherein the OPC recording is performed based on optical source drive characteristics obtained through the analysis of the optical source drive characteristics before the OPC recording and the OPC measurement.
